(19) United States
(12) Patent Application Publication
(10) Pub. No.: US 2016/0084797 A1
(43) Pub. Date: Mar. 24, 2016

(54) LEAK-PROOF GEL CASTING DEVICE FOR VERTICAL PROTEIN ELECTROPHORESIS SYSTEM

(71) Applicants: Chang Wook GOH, Seoul (KR); Cheon-ki KIM, (US)

(72) Inventors: Chang Wook GOH, Seoul (KR); Cheon-ki KIM, Chungcheongbuk-do (KR)

(73) Assignee: Chang Wook GOH, Seoul (KR)

(21) Appl. No.: 14/888,796

(22) PCT Filed: Jun. 13, 2013
(86) PCT No.: PCT/KR2013/005224

§ 371 Date: Nov. 3, 2015

(30) Foreign Application Priority Data
May 14, 2013 (KR) 10-2013-0054174

(51) Int. Cl. G01N 27/447

(52) U.S. Cl. CPC G01N 27/44704

(57) ABSTRACT

Disclosed is a leak-proof gel casting device for a vertical protein electrophoresis system which includes a gel caster which has a plurality of compartments and a sealing pad which is inserted to the compartments of the gel cater, and is formed to wrap around both sides and an edge of a lower side of a plate set. The present invention with a simple structure is capable of being manufactured at a low cost, does not require frequent replacement because of its long-term durability, and is highly effective in preventing the leakage of the gel placed in the gap between the plates.

### BACKGROUND OF THE INVENTION

1. Field of the Invention

The present invention relates to a leak-proof gel casting device, and more particularly to, a polyacrylamide gel plate used in a vertical electrophoresis system, using a gel casting device composed of a sealing pad and a gel caster with a simple structure. The leak-proof gel casting device seals so as to prevent leakage of gel between the slots at side portions and lower portions of a plate set.

2. Background of the Related Art

In general, an electrophoresis system has widely been used to analyze protein fractions in clinical laboratories. It is based on the phenomenon that positively charged particles move toward the cathode while negatively charged particles migrate toward the anode when the DC voltage is applied to charged particles in an electrolyte solution. If there are charged particles moving at different speeds but in the same direction, they gradually separate from each other at a certain speed during electrophoresis.

In 1807, Alexander Reuss, a Russian physicist, discovered the phenomenon known as electrophoresis in clay suspension. In the 1930, A. W. K. Tiselius, a Swedish biochemist developed a moving boundary electrophorosis (Tiselius electrophoresis apparatus). This moving boundary technique has contributed to the study of proteins such as an analysis of serum proteins. Since then, gel electrophoresis was introduced and has widely been used to separate proteins or nucleic acids and measure the molecular weight of proteins in the biochemical field.

Electrophoresis is divided into isotachophoresis, isoelectric electophoresis, and the like and according to the separation principle; divided into filter paper electrophoresis, gel electrophoresis, and the like by the type of its supporter; and slab electrophoresis, disc electrophoresis, and the like by the place of separation. Among the above, the gel electrophoresis is a general term for all types of electrophoresis using gel supporters. In general, polyacrylamide or agarose gels are used as supporters. Gels are used to prevent convection currents and protect samples. Polyacrylamide gel electrophoresis (SDS-PAGE) functions in the presence of sodium dodecylsulfate (SDS).

Gel electrophoresis is a method mainly used in the vertical electrophoresis device. An exemplary embodiment of the vertical electrophoretic system is illustrated in FIG. 1.

As described in FIG. 1, the electrophoretic system is composed of an electrophoretic device 1, a casting stand 2, a casting frame 3, a packing pad 4, a spacer plate 5 and a short plate 6, equipped with a fixed size spacer at the ends of both sides, and a comb 7. In order to manufacture an acrylamide gel plate (not illustrated) which is installed in the electrophoretic device, the following steps are required: making a spacer plate and a short plate to be close to each other to form a gap between them; install the plate set in the casting frame; inserting a casting frame to a casting stand horizontally, and placing a packing pad at the bottom of the casting stand in which the bottom of the plate set is placed, to prevent the acrylamide gel from leaking out to the bottom of the plate set.

Then, press down the upper edge of the plate set installed in the casting frame from the top with a lever type push pressure plate placed on the top of the casting stand; inject the separation gel into the gap between plates up to a certain height with a dispenser; harden the separation gel for about 30 minutes; inject stacking gel into the extra gap between plates with a dispenser; release the pressure plate; insert a comb into the place in which stacking gel is place between plates from top to bottom; put a protein sample in the chamber; place a set of plates with gel plates in an electrophoresis device 1 to electrophorese them. Consequently, the protein sample is separated in the vertical direction according to the molecular weight.

In the conventional electrophoretic system, it is required to tighten the plate set to prevent the leakage of the gel placed in the gap between the plates, and thus, a gel casting device includes a casting frame, a casting stand, and a packing pad. However, when plates are not closely stuck to each other due to weak clamping force of the side plastic pincers or the pressure plate, there are some cases that the injected gel is leaking.

In addition, the injected gel tends to leak because the packing pad supporting the bottom of the plate set is too stiff or has poor adhesive power. As a result, there is a problem that parts should often be replaced. Moreover, a level-type push pressure plate placed on an upper part of the casting stand does not often work properly because it is easily out of order or broken due to its material quality. Further, it is difficult to repair only the part having a deficiency, and thus, there is necessity to replace the whole casting stand, thereby causing economic losses.

### SUMMARY OF THE INVENTION

Therefore, the present invention has been made to solve the above-mentioned problems occurring in the gel caster commonly found in the conventional electrophoresis system. The object of the present invention is to provide a leak-proof gel casting device with a simple structure and a low cost which is capable of preventing the gel placed between plates from leaking out through the slots on the side and bottom of the plate.

In order to solve the above-mentioned problems, a leak-proof gel casting device for a vertical protein electrophoresis system according to an embodiment includes:

a gel caster configured to have a plurality of compartments, and

a sealing pad configured to be inserted to the compartments of the gel cater, the sealing pad being formed to wrap around both sides and an edge of a lower side of a plate set.

In addition, in the leak-proof gel casting device, the compartment of the gel caster is in a shape of “ [symbol] ”.

The gel caster is made of acrylic, synthetic resin, glass, or metal. In the leak-proof gel casting device, the plurality of compartments of the gel caster are disposed in front, back, left, and right directions on a plane or have a stepped structure.

In the leak-proof gel casting device, the sealing pad is in a shape of “ [symbol] ” in accordance with the shape of the compartments.

In the leak-proof gel casting device, a cross-sectional shape of the sealing pad is in a shape of “ [symbol] ”, and at both inner sides of the sealing pad, projections form a line around the edge.

The leak-proof casting device further includes a supplementary part in any side of outer sides of the sealing pad.

In the leak-proof casting device, the sealing pad is made of silicon or a mixture of silicon and synthetic resin.

The gel casting device used for the electrophoresis system with a simple structure is capable of being manufactured at a low cost, does not require frequent replacement because of its long-term durability, and is highly effective in preventing the leakage of the gel placed in the gap between the plates.

### BRIEF DESCRIPTION OF THE DRAWINGS

The above and/ or other aspects of the present inventive concept will be more apparent by describing certain exemplary embodiments of the present inventive concept with reference to the accompanying drawings, in which:

FIG. 1 illustrates the conventional electrophoresis system;

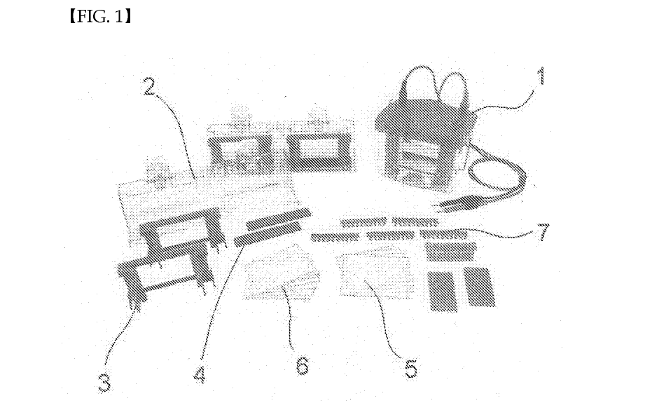

FIG. 2 illustrates an exploded view drawing of the leak-proof gel casting device in accordance with a task implementation example of this invention;

FIG. 3 is a drawing describing a state that a plate set is inserted in the sealing pad developed for this invention;

FIG. 4 is a drawing describing the front of the gel caster in FIG. 2;

FIG. 5 is a drawing illustrating a state that the plate set and the sealing pad are stored in each compartment of the gel caster in the leak-proof gel casting device in accordance with a task implementation example of this invention; and

FIG. 6 is a cross-sectional diagram seen from AA of FIG. 5.

### DETAILED DESCRIPTION OF THE PREFERRED EMBODIMENT

The exemplary embodiments may vary, and may be provided in different exemplary embodiments. Specific exemplary embodiments will be described with reference to accompanying drawings and detailed explanation. However, this does not necessarily limit the scope of the exemplary embodiments to a specific embodiment form. Instead, modifications, equivalents and replacements included in the disclosed concept and technical scope of this specification may be employed. While describing exemplary embodiments, if it is determined that the specific description regarding a known technology obscures the gist of the invention, the specific description is omitted.

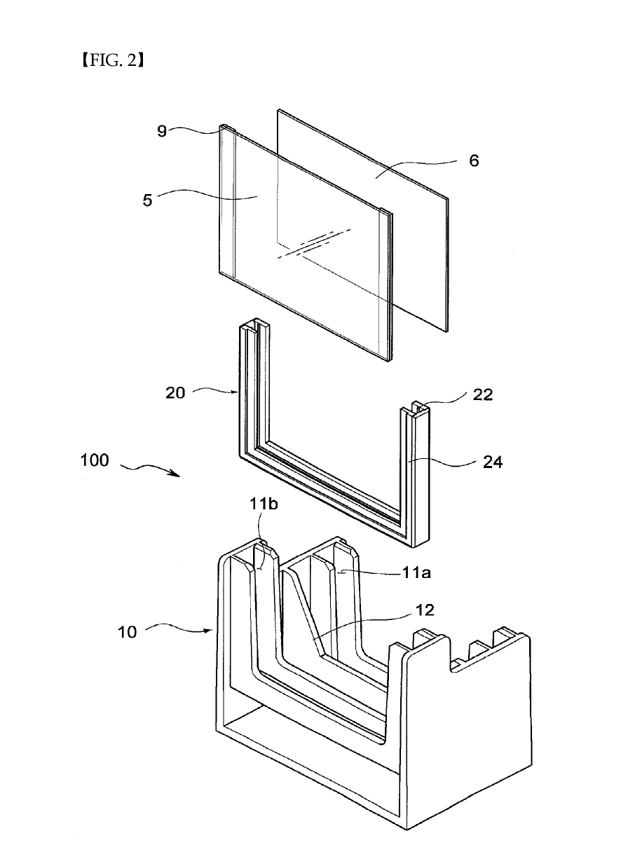

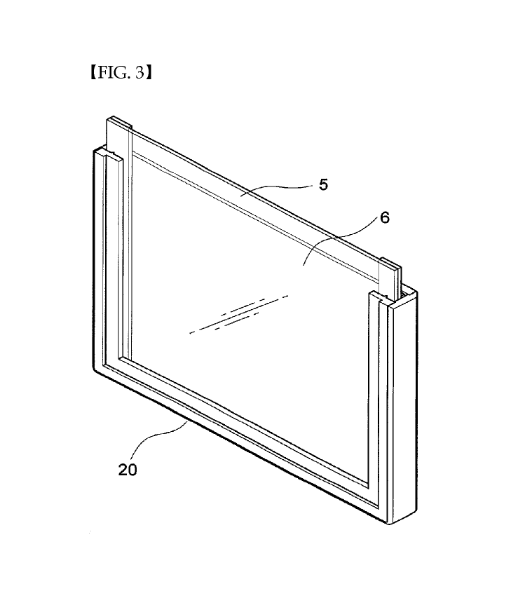

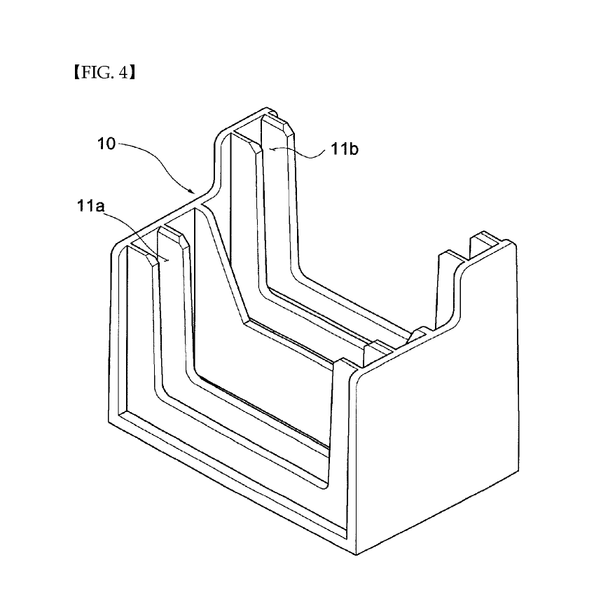

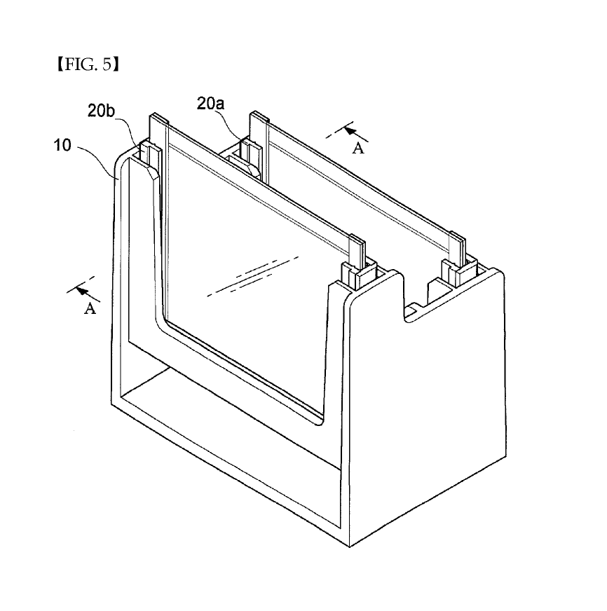

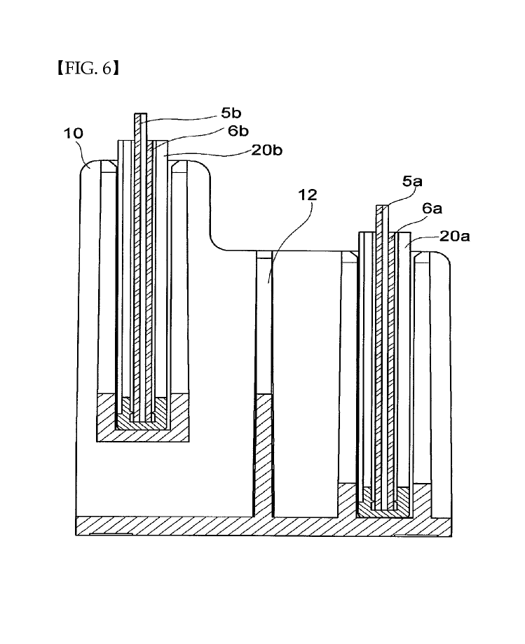

FIG. 2 illustrates an exploded view drawing of the leak-proof gel casting device in accordance with a task implementation example of this invention. FIG. 3 is a drawing describing a state that a plate set is inserted in the sealing pad developed for this invention. FIG. 4 is a drawing describing the front of the gel caster in FIG. 2. FIG. 5 is a drawing illustrating a state that the plate set and the sealing pad are stored in each compartment of the gel caster in the leak-proof gel casting device in accordance with a task implementation example of this invention. FIG. 6 is a cross-sectional diagram seen from AA of FIG. 5.

“Jel” and “Gel”, two Korean words used herein indicates ‘gel’ in English.

According to FIG. 2, a leak-proof gel casting device in the vertical electrophoresis system in accordance with a task implementation example is composed of two principal parts, a gel caster 10 with many compartments 11, 11a, and 11b and a sealing pad 20 which seems to wrap around the side and lower edges of plates 5 and 6, which is inserted into the compartment 11 of the above gel caster 10.

The gel caster 10 is used to manufacture gel plates to be electrophoresed.

The compartments 11; 11a,11b with the shape of “ [symbol] ”, which the top is opened while the bottom is closed, are placed in all directions (front, back, left, and right) on the plane or has a stepped structure separated like stairs. The reason why the compartment of the gel caster 10 has a stepped structure is that it is easy to measure the formation process of the gel plate at the front and form a chamber through the insertion of a comb after the gel injection.

Moreover, the compartment 11 has the shape of “ [symbol] ” to fit a sealing pad to be inserted into the compartment 20 to the shape of plates 5 and 6. However, the shape of the compartment is not limited to one described in this invention.

It is described that two compartments are formed in this invention. However, it is not limited to this number. One or many compartments can be formed or separated in all directions (front, back, left, and right) on the plane or with a stepped structure. Otherwise, a partition 12 can be formed between compartments. Compartments are separately placed or a partition is formed between compartments not to affect each other in the formation process of the gel plate and measure the process at the front easily.

It is desirable to manufacture the gel caster 10 from transparent acrylic or synthetic resin. It is also possible to manufacture it from translucent or opaque acrylic, synthetic resin, glass, or metal.

The sealing pad 20 is used to seal the slots 25 on the both sides and the bottoms of plates 5 and 6. It is a detachable pad inserted into the compartment 11 of the above gel caster 10. It has the shape of “ [symbol] ” in accordance with the shape of the compartment.

In addition, as described in FIG. 2, FIG. 3, and FIG. 6, the cross-sectional shape of the sealing pad takes the form of the letter “ [symbol] ”. Projections 22 form a line around the inner edge on both sides. When plates 5 and 6 are inserted, clamping force should be applied to each adjacent plate. Moreover, it is necessary to attach more supplementary parts 24 to one outer side of the sealing pad spacer plate 5 than the other side. A somewhat flexible gap is needed to maintain a dimensional tolerance between the thickness of plates and the inner width of the sealing pad, when a set of plates composed of a spacer plate 5 and a short plate 6 are inserted.

It is desirable to make the sealing pad from silicon with stretching force, elasticity, and adhesion, or a mixture of silicon and synthetic resin, in order to detach it from the compartment easily.

According to FIGS. 2 to 6, the process that a gel plate is formed with this invention, a leak-proof gel casting device, is described in detail as follows:

First, form the space between plates to place a spacer 9 between a set of plates, a spacer plate 5 and a short plate 6. Adjust it to the bottom and both sides.

Insert the bottom and side of the plates into the sealing pad 20 to seal the slot on the inner side and the bottom of the space between plates.

Insert many sealing pads in which plates are inserted into the compartments of the gel caster 20.

Inject a separation gel, a desired gel, into the gap between plates with a dispenser. Gradually inject stacking gel over the separation gel placed in the gap between plates after a certain amount of time required to harden the injected gel has elapsed. Insert a comb 7 from the top to form a chamber.

Put a protein sample in the chamber. Place a set of plates with gel plates in an electrophoresis device 1 to electrophorese them. Accordingly, the protein sample is separated in the vertical direction according to the molecular weight.

This invention has been explained with reference to implementation examples up to this point. It can easily be understand that people skilled in the relevant technical field can modify and change in many ways within the scope of thought and technology of this invention, which is described in the scope of patent claims described below.

### INDUSTRIAL APPLICABILITY

This invention intends to be used in the manufacturing process of the gel plate in the electrophoresis system. The present invention may be useful in the electrophoresis system with its benefits. Some of those benefits are as follows: it has a simple structure; it may be manufactured at low cost; it may not require frequent replacement because of its long-term durability; and it is not necessary to use any separate complicated equipment in order to prevent the leakage of the gel placed in the gap between the plates. Thus, the present invention is industrially applicable.

The foregoing embodiments and advantages are merely exemplary and are not to be construed as limiting. The present teaching may be readily applied to other types of apparatuses. Also, the description of the exemplary embodiments of the present inventive concept is intended to be illustrative, and not to limit the range of the claims, and many alternatives, modifications, and variations will be apparent to those skilled in the art.

[DESCRIPTION OF REFERENCE NUMERALS]

| | |
|---|---|
| 1: Electrophoresis device | 2: Casting stand |
| 3: Casting frame | 4: packing pad |
| 5: Spacer plate | 6: Short plate |
| 7: Comb | 9: Spacer |
| 10: Gel caster | 11, 11a, & 11b: Compartment |
| 12: Partition | 20, 20a, & 20b: Sealing pad |
| 22a & 22b: Projection | 24a & 24b: Supplementary parts |
| 25: Slot | 100: Gel casting device |

What is claimed is:

1. A leak-proof gel casting device for a vertical protein electrophoresis system, the device comprising:
a gel caster configured to have a plurality of compartments; and
a sealing pad configured to be inserted to the compartments of the gel cater, the sealing pad being formed to wrap around both sides and an edge of a lower side of a plate set.

2. The leak-proof gel casting device as claimed in claim 1, wherein the compartment of the gel caster is in a shape of “ [symbol] ”.

3. The leak-proof gel casting device as claimed in claim 1, wherein the gel caster is made of acrylic, synthetic resin, glass, or metal.

4. The leak-proof gel casting device as claimed in claim 1, wherein the plurality of compartments of the gel caster are disposed in front, back, left, and right directions on a plane or have a stepped structure.

5. The leak-proof gel casting device as claimed in claim 1, wherein the sealing pad is in a shape of “ [symbol] ” in accordance with the shape of the compartments.

6. The leak-proof gel casting device as claimed in claim 5, wherein a cross-sectional shape of the sealing pad is in a shape of “ [symbol] ”, and at both inner sides of the sealing pad, projections form a line around the edge.

7. The leak-proof casting device as claimed in claim 5, further comprising: a supplementary part in any side of outer sides of the sealing pad.

8. The leak-proof casting device as claimed in claim 1, wherein the sealing pad is made of silicon or a mixture of silicon and synthetic resin.
